(19) United States
(12) Patent Application Publication
(10) Pub. No.: US 2021/0383410 A1
(43) Pub. Date: Dec. 9, 2021

(54) Fraud Detection System and Method

(71) Applicant: Nuance Communications, Inc., Burlington, MA (US)

(72) Inventors: Haydar Talib, Montreal (CA); Damian Robo, Worcester, MA (US); Simon Marchand, Montreal (CA); Adiseshu Channasamudhram, Acton, MA (US)

(21) Appl. No.: 17/339,027

(22) Filed: Jun. 4, 2021

Related U.S. Application Data
(60) Provisional application No. 63/034,810, filed on Jun. 4, 2020.

(51) Int. Cl. G06Q 30/00; G06Q 10/06; H04M 3/436; H04M 3/42; H04W 76/30

(52) U.S. Cl. CPC G06Q 30/0185; G06Q 10/063112; H04W 76/30; H04M 3/42042; H04M 3/436

(57) ABSTRACT

A method, computer program product, and computing system for performing an assessment of initial input information, concerning a communication from a caller, to define an initial fraud-threat-level; if the initial fraud-threat-level is below a defined threat threshold, providing the communication to a recipient so that a conversation may occur between the recipient and the caller; performing an assessment of subsequent input information, concerning the conversation, to define a subsequent fraud-threat-level; and effectuating a targeted response based, at least in part, upon the subsequent fraud-threat-level, wherein the targeted response is intended to refine the subsequent fraud-threat-level.

### RELATED APPLICATION(S)

This application claims the benefit of U.S. Provisional Application No. 63/034,810, filed on 4 Jun. 2020, the entire contents of which are incorporated herein by reference.

### TECHNICAL FIELD

This disclosure relates to conversation monitoring and, more particularly, to systems and methods that monitor conversations to detect fraudsters.

### BACKGROUND

In many interactions between people (e.g., a customer calling a business and the customer service representative that handles the call), fraudsters often impersonate legitimate customers in an attempt to commit an act of fraud. For example, a fraudster my reach out to a credit card company and pretend to be a customer of the credit card company so that they may fraudulently obtain a copy to that customer's credit card. Unfortunately, these fraudsters are often successful, resulting in fraudulent charges, fraudulent monetary transfers, and identity theft. Further, these fraud attacks may be automated in nature, wherein e.g., a TDoS (i.e., a Telephony Denial of Services) type of attack may be implemented to disrupt the system itself. For obvious reasons, it is desirable to identify these fraudsters and prevent them from being successful.

### SUMMARY OF DISCLOSURE

In one implementation, a computer-implemented method is executed on a computing device and includes: performing an assessment of initial input information, concerning a communication from a caller, to define an initial fraud-threat-level; if the initial fraud-threat-level is below a defined threat threshold, providing the communication to a recipient so that a conversation may occur between the recipient and the caller; performing an assessment of subsequent input information, concerning the conversation, to define a subsequent fraud-threat-level; and effectuating a targeted response based, at least in part, upon the subsequent fraud-threat-level, wherein the targeted response is intended to refine the subsequent fraud-threat-level.

One or more of the following features may be included. If the initial fraud-threat-level is above the defined threat threshold, the communication may be terminated. The recipient may include one or more of: a high-fraud-risk specialist; and a general-fraud-risk representative. The initial input information may include one or more of: third-party information; and database information. The subsequent input information may include one or more of: a caller conversation portion; a recipient conversation portion; biometric information concerning the caller; third-party information; and database information. The conversation may include one or more of: a voice-based conversation between the caller and the recipient; and a text-based conversation between the caller and the recipient. Performing an assessment of initial input information may include: determining if the initial input information is indicative of fraudulent behavior. Performing an assessment of subsequent input information may include: determining if the subsequent input information is indicative of fraudulent behavior. Determining if the subsequent input information is indicative of fraudulent behavior may include: comparing the subsequent input information to a plurality of fraudulent behaviors. Effectuating a targeted response based, at least in part, upon the subsequent fraud-threat-level may include one or more of: allowing the conversation to continue; asking a question of the caller; prompting the recipient to ask a question of the caller; effectuating a transfer from the recipient to a high-fraud-risk specialist; and ending the conversation between the caller and the recipient.

In another implementation, a computer program product resides on a computer readable medium and has a plurality of instructions stored on it. When executed by a processor, the instructions cause the processor to perform operations including performing an assessment of initial input information, concerning a communication from a caller, to define an initial fraud-threat-level; if the initial fraud-threat-level is below a defined threat threshold, providing the communication to a recipient so that a conversation may occur between the recipient and the caller; performing an assessment of subsequent input information, concerning the conversation, to define a subsequent fraud-threat-level; and effectuating a targeted response based, at least in part, upon the subsequent fraud-threat-level, wherein the targeted response is intended to refine the subsequent fraud-threat-level.

One or more of the following features may be included. If the initial fraud-threat-level is above the defined threat threshold, the communication may be terminated. The recipient may include one or more of: a high-fraud-risk specialist; and a general-fraud-risk representative. The initial input information may include one or more of: third-party information; and database information. The subsequent input information may include one or more of: a caller conversation portion; a recipient conversation portion; biometric information concerning the caller; third-party information; and database information. The conversation may include one or more of: a voice-based conversation between the caller and the recipient; and a text-based conversation between the caller and the recipient. Performing an assessment of initial input information may include: determining if the initial input information is indicative of fraudulent behavior. Performing an assessment of subsequent input information may include: determining if the subsequent input information is indicative of fraudulent behavior. Determining if the subsequent input information is indicative of fraudulent behavior may include: comparing the subsequent input information to a plurality of fraudulent behaviors. Effectuating a targeted response based, at least in part, upon the subsequent fraud-threat-level may include one or more of: allowing the conversation to continue; asking a question of the caller; prompting the recipient to ask a question of the caller; effectuating a transfer from the recipient to a high-fraud-risk specialist; and ending the conversation between the caller and the recipient.

In another implementation, a computing system includes a processor and memory is configured to perform operations including performing an assessment of initial input information, concerning a communication from a caller, to define an initial fraud-threat-level; if the initial fraud-threat-level is below a defined threat threshold, providing the communication to a recipient so that a conversation may occur between the recipient and the caller; performing an assessment of subsequent input information, concerning the conversation, to define a subsequent fraud-threat-level; and effectuating a targeted response based, at least in part, upon the subsequent fraud-threat-level, wherein the targeted response is intended to refine the subsequent fraud-threat-level.

One or more of the following features may be included. If the initial fraud-threat-level is above the defined threat threshold, the communication may be terminated. The recipient may include one or more of: a high-fraud-risk specialist; and a general-fraud-risk representative. The initial input information may include one or more of: third-party information; and database information. The subsequent input information may include one or more of: a caller conversation portion; a recipient conversation portion; biometric information concerning the caller; third-party information; and database information. The conversation may include one or more of: a voice-based conversation between the caller and the recipient; and a text-based conversation between the caller and the recipient. Performing an assessment of initial input information may include: determining if the initial input information is indicative of fraudulent behavior. Performing an assessment of subsequent input information may include: determining if the subsequent input information is indicative of fraudulent behavior. Determining if the subsequent input information is indicative of fraudulent behavior may include: comparing the subsequent input information to a plurality of fraudulent behaviors. Effectuating a targeted response based, at least in part, upon the subsequent fraud-threat-level may include one or more of: allowing the conversation to continue; asking a question of the caller; prompting the recipient to ask a question of the caller; effectuating a transfer from the recipient to a high-fraud-risk specialist; and ending the conversation between the caller and the recipient.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a data acquisition system and a fraud detection process coupled to a distributed computing network;

FIG. 2 is a flow chart of an implementation of the fraud detection process of FIG. 1;

FIG. 3 is a diagrammatic view of a conversation transcript; and

FIG. 4 is a diagrammatic view of a plurality of fraudulent behaviors.

Like reference symbols in the various drawings indicate like elements.

### DETAILED DESCRIPTION OF THE PREFERRED EMBODIMENTS

### System Overview:

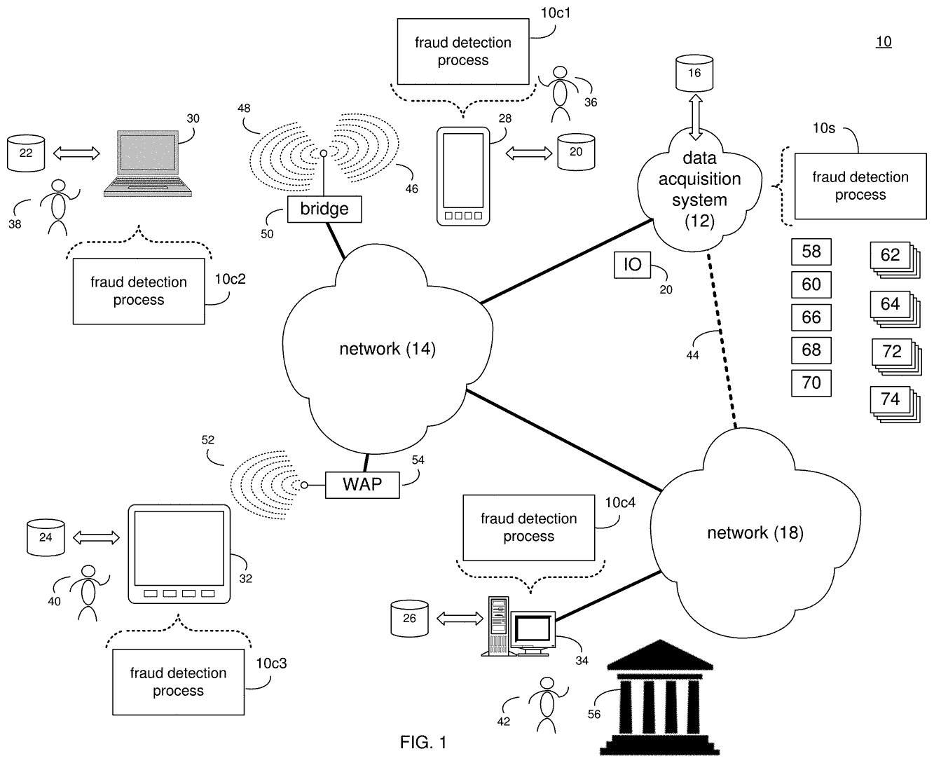

Referring to FIG. 1, there is shown fraud detection process 10. As will be discussed below in greater detail, fraud detection process 10 may be configured to interface with data acquisition system 12 and detect and/or frustrate fraudsters.

Fraud detection process 10 may be implemented as a server-side process, a client-side process, or a hybrid server-side/client-side process. For example, fraud detection process 10 may be implemented as a purely server-side process via fraud detection process 10s. Alternatively, fraud detection process 10 may be implemented as a purely client-side process via one or more of fraud detection process 10c1, fraud detection process 10c2, fraud detection process 10c3, and fraud detection process 10c4. Alternatively still, fraud detection process 10 may be implemented as a hybrid server-side/client-side process via fraud detection process 10s in combination with one or more of fraud detection process 10c1, fraud detection process 10c2, fraud detection process 10c3, and fraud detection process 10c4.

Accordingly, fraud detection process 10 as used in this disclosure may include any combination of fraud detection process 10s, fraud detection process 10c1, fraud detection process 10c2, fraud detection process 10c3, and fraud detection process 10c4.

Fraud detection process 10s may be a server application and may reside on and may be executed by data acquisition system 12, which may be connected to network 14 (e.g., the Internet or a local area network). Data acquisition system 12 may include various components, examples of which may include but are not limited to: a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (SaaS) systems, one or more software applications, one or more software platforms, a cloud-based computational system, and a cloud-based storage platform.

As is known in the art, a SAN may include one or more of a personal computer, a server computer, a series of server computers, a mini computer, a mainframe computer, a RAID device and a NAS system. The various components of data acquisition system 12 may execute one or more operating systems, examples of which may include but are not limited to: Microsoft Windows Server™; Redhat Linux™, Unix, or a custom operating system, for example.

The instruction sets and subroutines of fraud detection process 10s, which may be stored on storage device 16 coupled to data acquisition system 12, may be executed by one or more processors (not shown) and one or more memory architectures (not shown) included within data acquisition system 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Various IO requests (e.g. IO request 20) may be sent from fraud detection process 10s, fraud detection process 10c1, fraud detection process 10c2, fraud detection process 10c3 and/or fraud detection process 10c4 to data acquisition system 12. Examples of IO request 20 may include but are not limited to data write requests (i.e. a request that content be written to data acquisition system 12) and data read requests (i.e. a request that content be read from data acquisition system 12).

The instruction sets and subroutines of fraud detection process 10c1, fraud detection process 10c2, fraud detection process 10c3 and/or fraud detection process 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 20, 22, 24, 26 may include but are not limited to: hard disk drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, tablet computer 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access fraud detection process 10 directly through network 14 or through secondary network 18. Further, fraud detection process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, tablet computer 32 is shown wirelessly coupled to network 14 via wireless communication channel 52 established between tablet computer 32 and wireless access point (i.e., WAP) 54, which is shown directly coupled to network 14. Additionally, personal computer 34 is shown directly coupled to network 18 via a hardwired network connection.

### Fraud Detection Process:

As will be discussed below in greater detail, data acquisition system 12 may be configured to acquire data that concerns a communication from a caller and/or a subsequent conversation between the caller and a recipient (e.g., a platform user).

Examples of such a conversation between a caller (e.g., user 36) and a recipient (e.g., user 42) may include but are not limited to one or more of: a voice-based conversation between the caller (e.g., user 36) and the recipient (e.g., user 42); and a text-based conversation between the caller (e.g., user 36) and the recipient (e.g., user 42). For example, a customer may call a sales phone line to purchase a product; a customer may call a reservation line to book air travel; and a customer may text chat with a customer service line to request assistance concerning a product purchased or a service received.

While the following discussion concerns the authentication of a person calling into a help line (e.g., user 36), it is understood that fraud detection process 10 may be utilized to also authenticate the recipient (e.g., user 42) of such call.

Examples of such a communication may include but are not limited to the period proximate the initiation of the above-described voice call and/or text-session. For example, a communication may be the point after which the caller (e.g., user 36) initiated the voice call and/or text-session but before the point at which the recipient (e.g., user 42) engaged the caller (e.g., user 36).

Assume for the following example that the caller (e.g., user 36) is a customer who contacts bank 56 to request assistance concerning one or more of their bank accounts and the recipient (e.g., user 42) is a customer service employee of bank 56.

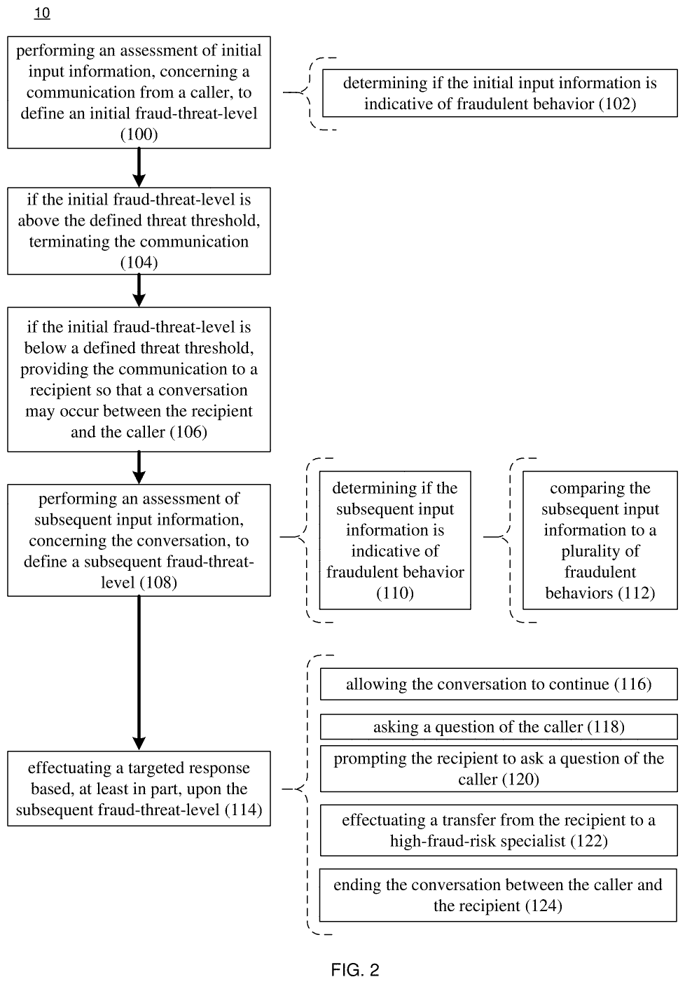

Referring also to FIG. 2, data acquisition system 12 may monitor the communication from the caller (e.g., user 36) and any subsequent conversation between the caller (e.g., user 36) and the recipient (e.g., user 42) to determine whether or not the caller (e.g., user 36) is a fraudster. For the following discussion, a fraudster may be a human being (e.g., a person that commits acts of fraud), a computer-based system (e.g., a speech “bot” that follows a script and uses artificial intelligence to respond to questions by the customer service representative), and a hybrid system (e.g., a person that commits acts of fraud but uses a computer-based system to change their voice).

Fraud detection process 10 may perform 100 an assessment of initial input information (e.g., initial input information 58) concerning a communication from a caller (e.g., user 36) to define an initial fraud-threat-level (e.g., initial fraud-threat-level 60). This threat level (e.g., initial fraud-threat-level 60) may be represented in various ways (e.g., as a number, a letter, a color, etc.), all of which are considered to be within the scope of this disclosure. For this example, this communication is the point after which the caller (e.g., user 36) initiates contact with bank 56 but prior to the caller (e.g., user 36) being engaged by the recipient (e.g., user 42).

Accordingly, assume for this example that the caller (e.g., user 36) dialed the customer help line for bank 56 (thus initiating contact with bank 56) and were informed that they were number “X” in the queue and were now listening to on hold music, thus the recipient (e.g., user 42) has not yet engaged the caller (e.g., user 36). During this wait, fraud detection process 10 may gather the above-referenced initial input information (e.g., initial input information 58). Examples of this initial input information (e.g., initial input information 58) may include one or more of: third-party information 62; and database information 64.

When performing 100 an assessment of the initial input information (e.g., initial input information 58), fraud detection process 10 may determine 102 if the initial input information (e.g., initial input information 58) is indicative of fraudulent behavior. For example, fraud detection process 10 may look at several pieces of information (e.g., third-party information 62 and/or database information 64), examples of which may include but are not limited to:
An ANI Validator: Fraud detection process 10 may utilize an ANI (i.e., Automatic Number Identification) validator to confirm that the actual phone number of the caller (e.g., user 36) matches the phone number that the caller is purporting to be, which may indicate a lower likelihood of fraud.
A Fraudster Database: Fraud detection process 10 may search a fraudster database to see if the actual phone number of the caller (e.g., user 36) or the originating IP address of the call is included within a fraudster database, which may indicate a higher likelihood of fraud.
SIP Headers: Fraud detection process 10 may process SIP (i.e., Session Initiation Protocol) headers to determine if there are any mismatches between what the caller (e.g., user 36) purports to be and what the caller (e.g., user 36) actually is, which may indicate a higher likelihood of fraud.
Call Frequency: Fraud detection process 10 may determine if the actual phone number of the caller (e.g., user 36) has a high call frequency. For example, if calls originate from this number several times per day/hour, this may indicate a higher likelihood of fraud.

For example and generally speaking, fraud detection process 10 may be configured to offload the call logs and SIP messages and identify those calling numbers that have certain characteristics (e.g., short burst calls or very long duration calls), wherein different calling pattern characteristics may be added to an existing library. Based on the data collected for those numbers that fall into the above characteristics, fraud detection process 10 may determine a calling frequency pattern.

Specifically, fraud detection process 10 may examine:
How many calls occur within a unit time;
If these calls are equally spaced in time;
The duration of each call; and/or
Source IP address of the call.

Depending upon the calling pattern, fraud detection process 10 may be configured to a) take action on its own and/or b) let the customer determine the action. Regardless of whether it is a system determined action or a customer recommended action, fraud detection process 10 may take one or more of the following actions on the calls from a particular calling number, examples of which may include but are not limited to:
Blocking the calls from that particular calling number at an SBC (i.e., Session Border Controller);
Referring the calls from that particular calling number for third-party ANI validation (i.e., in cases where the customer/client would have a partnership with ANI validators); and/or
Allowing the call from that particular calling number.

If the customer configures the system to take its own action, fraud detection process 10 may use the configured thresholds for each calling pattern and take the configured corresponding action.

If the initial fraud-threat-level (e.g., initial fraud-threat-level 60) is above a defined threat threshold (e.g., defined threat threshold 66), fraud detection process 10 may terminate 104 the communication. Defined threat threshold 66 may be defined by (in this example) bank 56 based upon e.g., their tolerance for dealing with fraudsters. It is foreseeable that some industries may set defined threat threshold 66 lower to better protect against fraudster (while possibly deeming some legitimate calls to be fraud). Conversely, some industries may set defined threat threshold 66 higher to reduce the likely of false-positive fraudster detection (while possibly being more exposed to fraudsters).

As an example, if the initial input information (e.g., initial input information 58) indicates that the communication is originating from a known fraudster number that is spoofing a legitimate phone number, the initial fraud-threat-level (e.g., initial fraud-threat-level 60) may exceed the defined threat threshold (e.g., defined threat threshold 66) and fraud detection process 10 may terminate 104 the communication.

Conversely, if the initial fraud-threat-level (e.g., initial fraud-threat-level 60) is below the defined threat threshold (e.g., defined threat threshold 66), fraud detection process 10 may provide 106 the communication to a recipient (e.g., user 42) so that a conversation may occur between the recipient (e.g., user 42) and the caller (e.g., user 36).

Depending upon the value of the initial fraud-threat-level (e.g., initial fraud-threat-level 60), the recipient (e.g., user 42) may be e.g., a high-fraud-risk specialist or a general-fraud-risk representative. For example, if the initial fraud-threat-level (e.g., initial fraud-threat-level 60) was not high enough to justify immediately terminating 104 the communication but is still higher than normal, fraud detection process 10 may provide 106 the communication to a recipient (e.g., user 42) who is a high-fraud-risk specialist, as there is an enhanced likelihood that the communication may be fraudulent. However, if the initial fraud-threat-level (e.g., initial fraud-threat-level 60) was not elevated, fraud detection process 10 may provide 106 the communication to a recipient (e.g., user 42) who is a general-fraud-risk representative, as there is a low likelihood that the communication may be fraudulent.

Accordingly and continuing with the above-stated example, a conversation may ensue between the caller (e.g., user 36) and the recipient (e.g., user 42), wherein fraud detection process 10 may monitor this conversation for evidence/indicators of fraud.

In the event that the monitored conversation is a voice-based conversation between the caller (e.g., user 36) and the recipient (e.g., user 42), fraud detection process 10 may process the voice-based conversation to define a conversation transcript for the voice-based conversation. For example, fraud detection process 10 may process the voice-based conversation to produce a conversation transcript using e.g., various speech-to-text platforms or applications (e.g., such as those available from Nuance Communications, Inc. of Burlington, Mass.). Naturally, in the event that the monitored conversation is a text-based conversation between the caller (e.g., user 36) and the recipient (e.g., user 42), fraud detection process 10 need not generate a conversation transcript, as the text-based conversation is its own transcript.

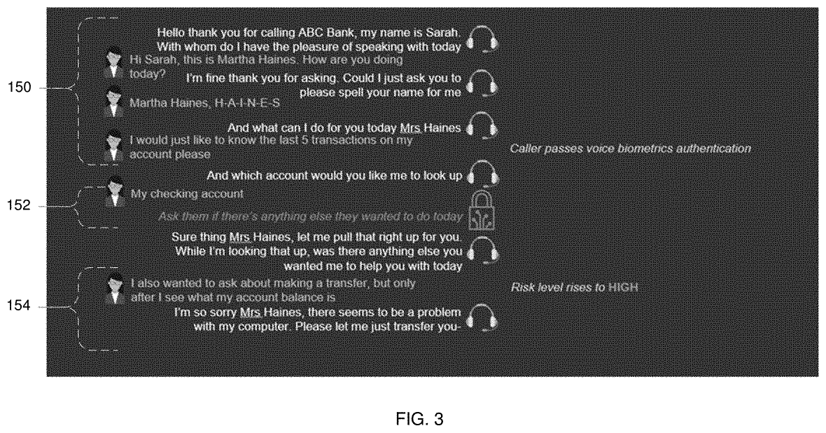

Referring also to FIG. 3, there is shown an example of such a conversation transcript between the caller (e.g., user 36) and the recipient (e.g., user 42). In this particular example, the conversation transcript is as follows:
User 36: Hello thank you for calling ABC Bank. My name is Sarah. With whom do I have the pressure of speaking with today?
User 42: Hi Sarah, this is Martha Haines. How are you doing today?
User 36: I'm fine thank you for asking. Could I ask you to please spell your name for me?
User 42: Martha Haines, H-A-I-N-E-S.
User 36: And what can I do for you today Mrs. Haines.
User 42: I would just like to know the last fine transactions on my account please.
(At this point in the conversation, fraud detection process 10 may determine that the caller (i.e., user 42) has passed voice biometrics authentication)
User 36: And which account would you like me to look up?
User 42: My checking account.
(At this point in time, fraud detection process 10 may ask the caller (i.e., user 42) if there is anything else they wanted to do today)
User 36: Sure thing Mrs. Haines, let me pull that right up for you. While I'm looking that up, was there anything else you wanted me to help you with today?
User 42: I also wanted to ask about making a transfer, but only after I see what my account balance is.
(At this point in time, fraud detection process 10 may raise the fraud threat to HIGH)
User 36: I'm so sorry Mrs. Haines, there seems to be a problem with my computer. Please let me transfer you.

Based upon the above-described interaction between the caller (e.g., user 36) and the recipient (e.g., user 42), fraud detection process 10 may perform 108 an assessment of subsequent input information (e.g., subsequent input information 68), concerning the conversation, to define a subsequent fraud-threat-level (e.g., subsequent fraud-threat-level 70). This threat level (e.g., subsequent fraud-threat-level 70) may be represented in various ways (e.g., as a number, a letter, a color, etc.), all of which are considered to be within the scope of this disclosure.

Examples of subsequent input information (e.g., subsequent input information 68) may include but are not limited to one or more of:
biometric information (e.g., biometric information 68), such as inflection patterns, accent patterns, pause patterns, word choice patterns, speech speed patterns, speech cadence patterns, speech rhythm patterns, word length patterns, voice print information, and stress level information concerning the caller (e.g., user 36);
third-party information (e.g., third-party information 62), such as information included within a fraudster database and an ANI validator; and
database information (e.g., database information 64), such as information included within a call frequency database.
a caller conversation portion, such as a word, phrase, comment or sentence spoken or typed by the caller (e.g., user 36);
a recipient conversation portion, such as a word, phrase, comment or sentence spoken or typed by the recipient (e.g., user 42);

Specifically and with respect to such biometric information (e.g., biometric information 68), fraud detection process 10 may analyze various speech pattern indicia defined within the conversation between the caller (e.g., user 36) and the recipient (e.g., user 42).
Inflections: Fraud detection process 10 may process the conversation between the caller (e.g., user 36) and the recipient (e.g., user 42) to define one or more inflection patterns of the caller (e.g., user 36). As is known in the art, an inflection is an aspect of speech in which the speaker modifies the pronunciation of a word to express different grammatical categories (such as tense, case, voice, aspect, person, number, gender, and mood). Specifically, certain people may speak in certain manners wherein they may add specific inflections on e.g., the last words of a sentence. Such inflection patterns may be utilized by fraud detection process 10 to identify the provider of such content.
Accent Patterns: Fraud detection process 10 may process the conversation between the caller (e.g., user 36) and the recipient (e.g., user 42) to define one or more accent patterns of the caller (e.g., user 36). As is known in the art, different people of different ethnic origins may pronounce the same words differently (e.g., a native-born American speaking English, versus a person from the United Kingdom speaking English, versus a person from India speaking English). Further, people of common ethic origin may pronounce the same words differently depending upon the particular geographic region in which they are located (e.g., a native-born American from New York City versus a native-born American from Dallas, Tex.). Such accent patterns may be utilized by fraud detection process 10 to identify the provider of such content.
Pause Patterns: Fraud detection process 10 may process the conversation between the caller (e.g., user 36) and the recipient (e.g., user 42) to define one or more pause patterns of the caller (e.g., user 36). As is known in the art, various people speak in various ways. Some people continuously speak without pausing, while other people may introduce a considerable number of pauses into their speech, while others may fill those pauses with filler words (e.g., “ummm”, “you know”, and “like”). Such pause patterns may be utilized by fraud detection process 10 to identify the provider of such content.
Word Choice Patterns: Fraud detection process 10 may process the conversation between the caller (e.g., user 36) and the recipient (e.g., user 42) to define one or more word choice patterns of the caller (e.g., user 36). Specifically, certain people tend to frequently use certain words. For example, one person may frequently use “typically” while another person may frequently use “usually”. Such word choice patterns may be utilized by fraud detection process 10 to identify the provider of such content.

While four specific examples of speech-pattern indicia are described above (namely: inflection patterns, accent patterns, pause patterns, and word choice patterns), this is for illustrative purposes only and is not intended to be a limitation of this disclosure, as other configurations are possible and are considered to be within the scope of this disclosure. Accordingly, other examples of such speech-pattern indicia may include but are not limited to speech speed patterns, speech cadence patterns, speech rhythm patterns, word length patterns, voice print information, stress level information etc. For example, fraud detection process 10 may also utilize question/answer pairings to provide insight as to whether a caller is a fraudster.

When performing 108 an assessment of subsequent input information (e.g., subsequent input information 68), fraud detection process 10 may determine 110 if the subsequent input information (e.g., subsequent input information 68) is indicative of fraudulent behavior.

For example, fraud detection process 10 may determine 110 if biometric information 68 (e.g., inflection patterns, accent patterns, pause patterns, word choice patterns, speech speed patterns, speech cadence patterns, speech rhythm patterns, word length patterns, voice print information, stress level information) associated with the caller (e.g., user 36) is indicative of fraudulent behavior. Additionally/alternatively, fraud detection process 10 may determine 110 if third-party information 62 (e.g., information included within a fraudster database and an ANI validator) is indicative of fraudulent behavior. Additionally/alternatively, fraud detection process 10 may determine 110 if database information 64 (e.g., information included within a call frequency database) is indicative of fraudulent behavior. Additionally/alternatively, fraud detection process 10 may determine 110 if a word or phrase (e.g., subsequent input information 68) uttered or typed by the caller (e.g., user 36) is indicative of fraudulent behavior.

Accordingly and when determining 110 if the subsequent input information (e.g., subsequent input information 68) is indicative of fraudulent behavior. fraud detection process 10 may examine various criteria, examples of which may include but are not limited to:
Age Detection: Fraud detection process 10 may be configured to detect the age group of the caller (e.g., user 36). Further and given prior knowledge of the caller's birthday (which may be defined within e.g., bibliographic information associated with the caller), fraud detection process 10 may compare this defined information with the detected age group to identify mismatches, wherein fraud detection process 10 may consider this comparison information when defining subsequent fraud-threat-level 70. Additionally, fraud detection process 10 may utilize this information for routing purposes, as seniors are disproportionately the victims of identity theft. So fraud detection process 10 may expedite the processing of calls from seniors. Additionally/alternatively and/or instead of relying solely on a caller's birthday, fraud detection process 10 may detect the age of the caller (e.g., user 36) at different times. Accordingly, fraud detection process 10 may detect the age of the caller (e.g., user 36) today and may compare that detected age to the age of the caller when they called e.g., two weeks ago. Accordingly and due to the minimal time difference between those two calls, fraud detection process 10 should detect the caller (e.g., user 36) as being that same age today as they were two weeks ago. However, if fraud detection process 10 detected the age of the caller (e.g., user 36) as e.g., 50-59 years old two weeks ago and 20-29 years old today, this is likely indicative of a problem.
Gender Detection: Fraud detection process 10 may be configured to detect the gender of the caller (e.g., user 36). Further and given prior knowledge of the caller's gender (which may be defined within e.g., bibliographic information associated with the caller), fraud detection process 10 may compare this defined information with the detected gender to identify mismatches, wherein fraud detection process 10 may consider this comparison information when defining subsequent fraud-threat-level 70.
Language Detection: Fraud detection process 10 may be configured to detect the primary language of the caller (e.g., user 36). Given prior knowledge of the caller's primary language (which may be defined within e.g., bibliographic information associated with the caller), fraud detection process 10 may be configured to compare this defined information with the detected primary language to identify mismatches, wherein fraud detection process 10 may consider this comparison information when defining subsequent fraud-threat-level 70. Additionally, fraud detection process 10 may utilize this information for routing purposes, as routing a call from e.g., a native French speaker to a recipient who can speak French may expedite the processing of such calls.
Dark Web Presence: Fraud detection process 10 may be configured to extract data from the Dark Web to determine if a claimed identity of the caller (e.g., user 36) may have previously been the victim of identity theft or largescale data breach (e.g. Equifax), wherein fraud detection process 10 may consider this information when defining subsequent fraud-threat-level 70.
Phone Number Databases: Fraud detection process 10 may be configured to review published databases of phone numbers associated with criminal activity, wherein fraud detection process 10 may consider this information when defining subsequent fraud-threat-level 70.

When determining 110 if the subsequent input information (e.g., subsequent input information 68) is indicative of fraudulent behavior, fraud detection process 10 may compare 112 the subsequent input information (e.g., subsequent input information 68) to a plurality of fraudulent behaviors (e.g., plurality of fraudulent behaviors 72).

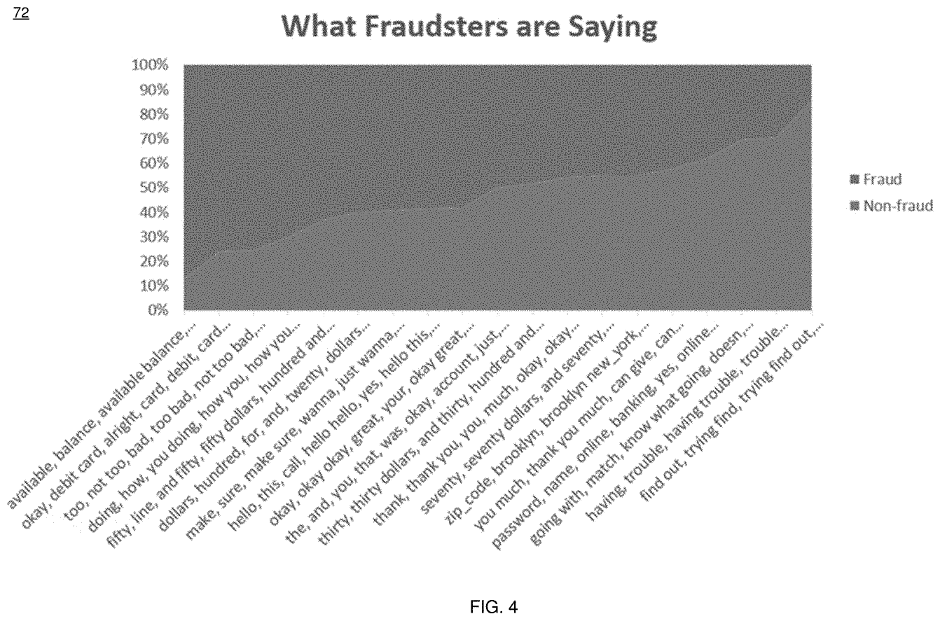

Referring also to FIG. 4, there is shown a visual example of such a plurality of fraudulent behaviors (e.g., plurality of fraudulent behaviors 72). As shown in this particular example, the items on the left side of the graph (e.g., inquiries about account balances) have a high probability of being fraudulent behavior (90% fraudulent versus 10% legitimate), while the items on the right side of the graph (e.g., requests for help) have a low probability of being fraudulent behavior (10% fraudulent versus 90% legitimate).

The plurality of fraudulent behaviors (e.g., plurality of fraudulent behaviors 72) may include a plurality of empirically-defined fraudulent behaviors, wherein this plurality of empirically-defined fraudulent behaviors may be defined via AI/ML processing of information concerning a plurality of earlier conversations.

For example, assume that fraud detection process 10 has access to a data set (e.g., data set 74) that quantifies interactions between customer service representatives and those callers (both legitimate and fraudulent) that reached out to those customer service representatives. For this example, assume that the interactions defined within this data set (e.g., data set 74) identify inquiries made by the callers and the results of the interaction. Accordingly and by processing such interactions defined within this data set (e.g., data set 74), this plurality of empirically-defined fraudulent behaviors may be defined (via AI/ML processing), resulting in the plurality of fraudulent behaviors 72 defined within FIG. 4.

Fraud detection process 10 may effectuate 114 a targeted response based, at least in part, upon the subsequent fraud-threat-level (e.g., subsequent fraud-threat-level 70), wherein the targeted response is intended to refine the subsequent fraud-threat-level (e.g., subsequent fraud-threat-level 70).

When effectuating 114 the targeted response, fraud detection process 10 may:
allow 116 the conversation to continue;
ask 118 a question of the caller (e.g., user 36);
prompt 120 the recipient (e.g., user 42) to ask a question of the caller (e.g., user 36);
effectuate 122 a transfer from the recipient (e.g., user 42) to a high-fraud-risk specialist; and
end 124 the conversation between the caller (e.g., user 36) and the recipient (e.g., user 42).

For example and if fraud detection process 10 performs 108 an assessment of the subsequent input information (e.g., subsequent input information 68) and assesses a subsequent fraud-threat-level (e.g., subsequent fraud-threat-level 70) that is low, fraud detection process 10 may effectuate 114 a targeted response that allows 116 the conversation to continue. Accordingly and during portion 150 of the conversation transcript shown in FIG. 3, fraud detection process 10 may assess a subsequent fraud-threat-level (e.g., subsequent fraud-threat-level 70) of low and may allow 116 the conversation to continue.

Further and if fraud detection process 10 performs 108 an assessment of the subsequent input information (e.g., subsequent input information 68) and assesses a subsequent fraud-threat-level (e.g., subsequent fraud-threat-level 70) that is intermediate, fraud detection process 10 may effectuate 114 a targeted response that asks 118 a question of the caller (e.g., user 36). Accordingly and during portion 152 of the conversation transcript shown in FIG. 3, fraud detection process 10 may assess a subsequent fraud-threat-level (e.g., subsequent fraud-threat-level 70) of intermediate and may ask 118 a question of the caller (e.g., user 36). In this particular example, the question asked (“was there anything else you wanted me to help you with today?”) may be directly asked via a synthesized voice (if a voice-based exchange) or via text (if a text-based exchange).

Alternatively and if fraud detection process 10 performs 108 an assessment of the subsequent input information (e.g., subsequent input information 68) and assesses a subsequent fraud-threat-level (e.g., subsequent fraud-threat-level 70) that is intermediate, fraud detection process 10 may effectuate 114 a targeted response that prompts 120 the recipient (e.g., user 42) to ask a question of the caller (e.g., user 36). Accordingly and during portion 152 of the conversation transcript shown in FIG. 3, fraud detection process 10 may assess a subsequent fraud-threat-level (e.g., subsequent fraud-threat-level 70) of intermediate and may prompt 120 a question of the caller (e.g., user 36). In this particular example, the question asked (“was there anything else you wanted me to help you with today?”) may be indirectly asked via the recipient (e.g., user 42) after prompting by fraud detection process 10.

Further and if fraud detection process 10 performs 108 an assessment of the subsequent input information (e.g., subsequent input information 68) and assesses a subsequent fraud-threat-level (e.g., subsequent fraud-threat-level 70) that is high, fraud detection process 10 may effectuate 114 a targeted response that effectuates 122 a transfer from the recipient (e.g., user 42) to a high-fraud-risk specialist. Accordingly and during portion 154 of the conversation transcript shown in FIG. 3, fraud detection process 10 may assess a subsequent fraud-threat-level (e.g., subsequent fraud-threat-level 70) of high and may effectuate 122 a transfer of the caller (e.g., user 36) from the recipient (e.g., user 42) to a high-fraud-risk specialist (such as a supervisor or a manager).

Alternatively and if fraud detection process 10 performs 108 an assessment of the subsequent input information (e.g., subsequent input information 68) and assesses a subsequent fraud-threat-level (e.g., subsequent fraud-threat-level 70) that is high, fraud detection process 10 may effectuate 114 a targeted response that ends 124 the conversation between the caller (e.g., user 36) and the recipient (e.g., user 42). Accordingly and when detecting a fraud-threat-level (e.g., fraud-threat-level 62) of high, fraud detection process 10 may end 124 the conversation between the caller (e.g., user 36) and the recipient (e.g., user 42) by disconnecting the call.

While described above are five targeted responses that may be effectuated 114 by fraud detection process 10, this is for illustrative purposes only and is not intended to be a limitation of this disclosure, as other configurations are possible and are considered to be within the scope of this disclosure. For example and when effectuating 114 a targeted response, fraud detection process 10 may display a result/decision to the recipient (e.g., user 42); and/or may display a result/decision to a backend analyst (not shown).

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
performing an assessment of initial input information, concerning a communication from a caller, to define an initial fraud-threat-level;
if the initial fraud-threat-level is below a defined threat threshold, providing the communication to a recipient so that a conversation may occur between the recipient and the caller;
performing an assessment of subsequent input information, concerning the conversation, to define a subsequent fraud-threat-level; and
effectuating a targeted response based, at least in part, upon the subsequent fraud-threat-level, wherein the targeted response is intended to refine the subsequent fraud-threat-level.

2. The computer-implemented method of claim 1 further comprising:
if the initial fraud-threat-level is above the defined threat threshold, terminating the communication.

3. The computer-implemented method of claim 1 wherein the recipient includes one or more of:
a high-fraud-risk specialist; and
a general-fraud-risk representative.

4. The computer-implemented method of claim 1 wherein the initial input information includes one or more of:
third-party information; and
database information.

5. The computer-implemented method of claim 1 wherein the subsequent input information includes one or more of:
a caller conversation portion;
a recipient conversation portion;
biometric information concerning the caller;
third-party information; and
database information.

6. The computer-implemented method of claim 1 wherein the conversation includes one or more of:
a voice-based conversation between the caller and the recipient; and
a text-based conversation between the caller and the recipient.

7. The computer-implemented method of claim 1 wherein performing an assessment of initial input information includes:
determining if the initial input information is indicative of fraudulent behavior.

8. The computer-implemented method of claim 1 wherein performing an assessment of subsequent input information includes:
determining if the subsequent input information is indicative of fraudulent behavior.

9. The computer-implemented method of claim 8 wherein determining if the subsequent input information is indicative of fraudulent behavior includes:
comparing the subsequent input information to a plurality of fraudulent behaviors.

10. The computer-implemented method of claim 1 wherein effectuating a targeted response based, at least in part, upon the subsequent fraud-threat-level includes one or more of:
allowing the conversation to continue;
asking a question of the caller;
prompting the recipient to ask a question of the caller;
effectuating a transfer from the recipient to a high-fraud-risk specialist; and
ending the conversation between the caller and the recipient.

11. A computer program product residing on a computer readable medium having a plurality of instructions stored thereon which, when executed by a processor, cause the processor to perform operations comprising:
performing an assessment of initial input information, concerning a communication from a caller, to define an initial fraud-threat-level;
if the initial fraud-threat-level is below a defined threat threshold, providing the communication to a recipient so that a conversation may occur between the recipient and the caller;
performing an assessment of subsequent input information, concerning the conversation, to define a subsequent fraud-threat-level; and
effectuating a targeted response based, at least in part, upon the subsequent fraud-threat-level, wherein the targeted response is intended to refine the subsequent fraud-threat-level.

12. The computer program product of claim 11 further comprising:
if the initial fraud-threat-level is above the defined threat threshold, terminating the communication.

13. The computer program product of claim 11 wherein the recipient includes one or more of:
a high-fraud-risk specialist; and
a general-fraud-risk representative.

14. The computer program product of claim 11 wherein the initial input information includes one or more of:
third-party information; and
database information.

15. The computer program product of claim 11 wherein the subsequent input information includes one or more of:
a caller conversation portion;
a recipient conversation portion;
biometric information concerning the caller;
third-party information; and
database information.

16. The computer program product of claim 11 wherein the conversation includes one or more of:
a voice-based conversation between the caller and the recipient; and
a text-based conversation between the caller and the recipient.

17. The computer program product of claim 11 wherein performing an assessment of initial input information includes:
determining if the initial input information is indicative of fraudulent behavior.

18. The computer program product of claim 11 wherein performing an assessment of subsequent input information includes:
determining if the subsequent input information is indicative of fraudulent behavior.

19. The computer program product of claim 18 wherein determining if the subsequent input information is indicative of fraudulent behavior includes:
comparing the subsequent input information to a plurality of fraudulent behaviors.

20. The computer program product of claim 11 wherein effectuating a targeted response based, at least in part, upon the subsequent fraud-threat-level includes one or more of:
allowing the conversation to continue;
asking a question of the caller;
prompting the recipient to ask a question of the caller;
effectuating a transfer from the recipient to a high-fraud-risk specialist; and
ending the conversation between the caller and the recipient.

21. A computing system including a processor and memory configured to perform operations comprising:
performing an assessment of initial input information, concerning a communication from a caller, to define an initial fraud-threat-level;
if the initial fraud-threat-level is below a defined threat threshold, providing the communication to a recipient so that a conversation may occur between the recipient and the caller;
performing an assessment of subsequent input information, concerning the conversation, to define a subsequent fraud-threat-level; and
effectuating a targeted response based, at least in part, upon the subsequent fraud-threat-level, wherein the targeted response is intended to refine the subsequent fraud-threat-level.

22. The computing system of claim 21 further comprising:
if the initial fraud-threat-level is above the defined threat threshold, terminating the communication.

23. The computing system of claim 21 wherein the recipient includes one or more of:
a high-fraud-risk specialist; and
a general-fraud-risk representative.

24. The computing system of claim 21 wherein the initial input information includes one or more of:
third-party information; and
database information.

25. The computing system of claim 21 wherein the subsequent input information includes one or more of:
a caller conversation portion;
a recipient conversation portion;
biometric information concerning the caller;
third-party information; and
database information.

26. The computing system of claim 21 wherein the conversation includes one or more of:
a voice-based conversation between the caller and the recipient; and
a text-based conversation between the caller and the recipient.

27. The computing system of claim 21 wherein performing an assessment of initial input information includes:
determining if the initial input information is indicative of fraudulent behavior.

28. The computing system of claim 21 wherein performing an assessment of subsequent input information includes:
determining if the subsequent input information is indicative of fraudulent behavior.

29. The computing system of claim 28 wherein determining if the subsequent input information is indicative of fraudulent behavior includes:
comparing the subsequent input information to a plurality of fraudulent behaviors.

30. The computing system of claim 21 wherein effectuating a targeted response based, at least in part, upon the subsequent fraud-threat-level includes one or more of:
allowing the conversation to continue;
asking a question of the caller;
prompting the recipient to ask a question of the caller;
effectuating a transfer from the recipient to a high-fraud-risk specialist; and
ending the conversation between the caller and the recipient.
